(19) United States
(12) Patent Application Publication
(10) Pub. No.: US 2018/0366139 A1
(43) Pub. Date: Dec. 20, 2018

(54) EMPLOYING VEHICULAR SENSOR INFORMATION FOR RETRIEVAL OF DATA

(71) Applicants: Upton Beall Bowden, Canton, MI (US); J. William Whikehart, Milford, MI (US); Markus Schupfner, Van Buren Township, MI (US)

(72) Inventors: Upton Beall Bowden, Canton, MI (US); J. William Whikehart, Milford, MI (US); Markus Schupfner, Van Buren Township, MI (US)

(21) Appl. No.: 15/623,056

(22) Filed: Jun. 14, 2017

(51) Int. Cl. G10L 25/51; G06K 9/00; G06K 9/46; G10L 25/30; H04R 1/40; G06N 3/04; G06N 3/08

(52) U.S. Cl. CPC G10L 25/51; G06K 9/00791; G06K 9/4628; G06N 3/08; H04R 1/406; G06N 3/04; G10L 25/30

(57) ABSTRACT

Disclosed herein are systems, methods, and devices for optimally performing object identification employing a neural network (NN), for example a convolutional neural network (CNN). The aspects disclosed herein employ audio data captured by one or more microphones in to at least identify an object, or augment image capturing to perform the same. The audio data and the image data are each propagated to the NN, to perform object identification.

### BACKGROUND

Vehicles, such as automobiles, motorcycles and the like—are being provided with image or video capturing devices to capture surrounding environments. These devices are being provided so as to allow for an enhanced driving experience. With surrounding environments being captured by sensors, through processing, the surrounding environment can be identified, or objects in the surrounding environment may also be identified.

For example, a vehicle implementing an image capturing device configured to capture a surrounding environment may detect road signs indicating danger or information, highlight local attractions and other objects for education and entertainment, and provide a whole host of other services.

This technology becomes even more important as autonomous vehicles are introduced. An autonomous vehicle employs many sensors to determine an optimal driving route and technique. One such sensor is the capturing of real-time images of the surrounding area, and processing driving decisions based on said captured image.

FIGS. 1(a) and (b) illustrate an example of a vehicle 100 employing the aspects disclosed herein. As shown, the vehicle 100 may be able to capture objects around said vehicle, such as a pedestrian 150 or another vehicle 130. These objects (prior to identification merely being demarcated by regions 140 or 120) may be captured and sent to a centralized processing server to be classified and identified.

As shown in FIG. 1(b), the objects are communicated, and correctly identified. Thus, the object in box 140 is identified/classified as a ‘pedestrian’ and the object in box 120 is identified as a ‘vehicle’.

Processing power of devices situated in vehicles have improved and become more powerful. Conversely, operations needed to be performed in the vehicular context have also become more intensive. One such organization technique for allowing processing is a convolutional neural network (CNN) as shown in FIG. 2. The CNN allows for a processing method which has processing characteristics that have been previously optimized to perform the identification of objects based on data about the objects to be identified. The CNN may be trained accordingly through various object identification tasks.

Referring specifically to the CNN, the first layer includes a set of nodes that receives the captured data, such as image data, and provides outputs to be input by the next layer. Each subsequent layer consists of a set of nodes which receive inputs from the previous layer, except the last layer, which outputs the identification of the object. A node acts as an artificial neuron and as an example calculates a weighted sum of its inputs, and then applies an activation function to the sum to produce a single output.

Thus, because the process of searching every data item becomes potentially processor intensive, vehicle implementers are attempting to incorporate processors with greater capabilities and processor power. Therefore, the price of components needing to be implemented in a vehicle-based computing system is increased.

### SUMMARY

The following description relates to employing vehicular sensor information for retrieval of data. Exemplary embodiments may also be directed to any of the system, the method, or an application disclosed herein, and the subsequent implementation in existing vehicular systems, microprocessors, and autonomous vehicle driving systems.

Additional features of the invention will be set forth in the description which follows, and in part will be apparent from the description, or may be learned by practice of the invention.

Disclosed herein are systems, methods, and devices for optimally performing object identification employing a neural network (NN), for example a convolutional neural network (CNN). The aspects disclosed herein employ audio data captured by one or more microphones in to at least identify an object, or augment image capturing to perform the same. The audio data and the image data are each propagated to the NN, to perform object identification.

It is to be understood that both the foregoing general description and the following detailed description are exemplary and explanatory and are intended to provide further explanation of the invention as claimed. Other features and aspects will be apparent from the following detailed description, the drawings, and the claims.

### DESCRIPTION OF THE DRAWINGS

The detailed description refers to the following drawings, in which like numerals refer to like items, and in which:

FIGS. 1(a) and (b) illustrate an example of a vehicle employing object identification according to a conventional implementation;

FIG. 2 illustrates an example implementation of a convolutional neural network employed to perform object identification;

FIGS. 3(a) and (b) illustrate an example system employing the aspects disclosed herein a vehicular-based context;

FIG. 4 illustrates a first implementation of the microprocessor shown in FIG. 3(a); and

FIG. 5 illustrates a second implementation of the microprocessor shown in FIG. 3 (a).

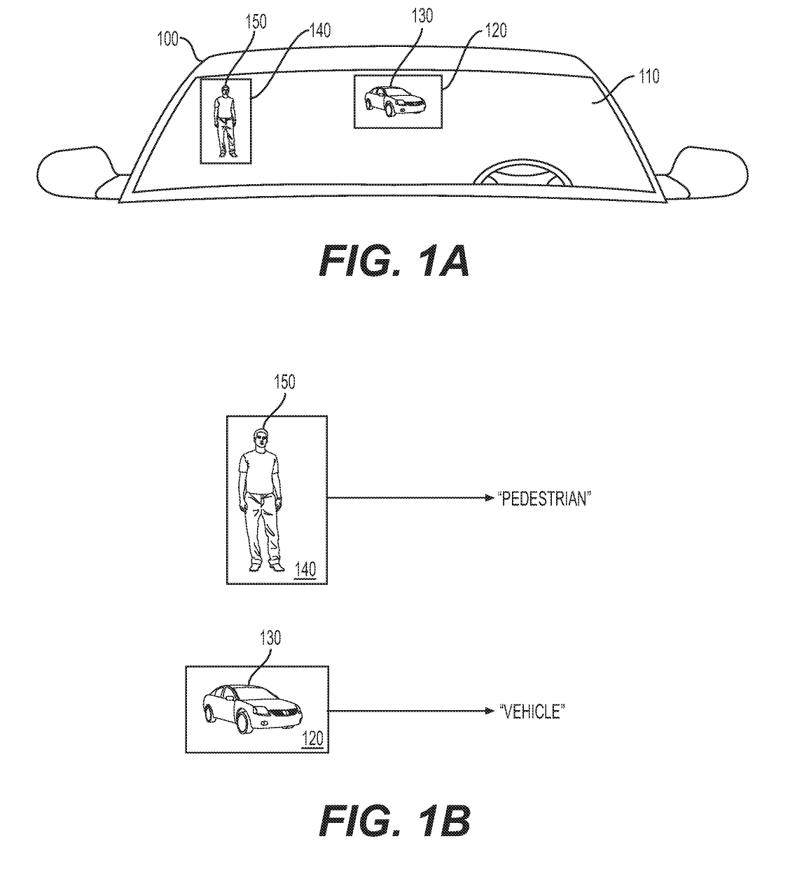

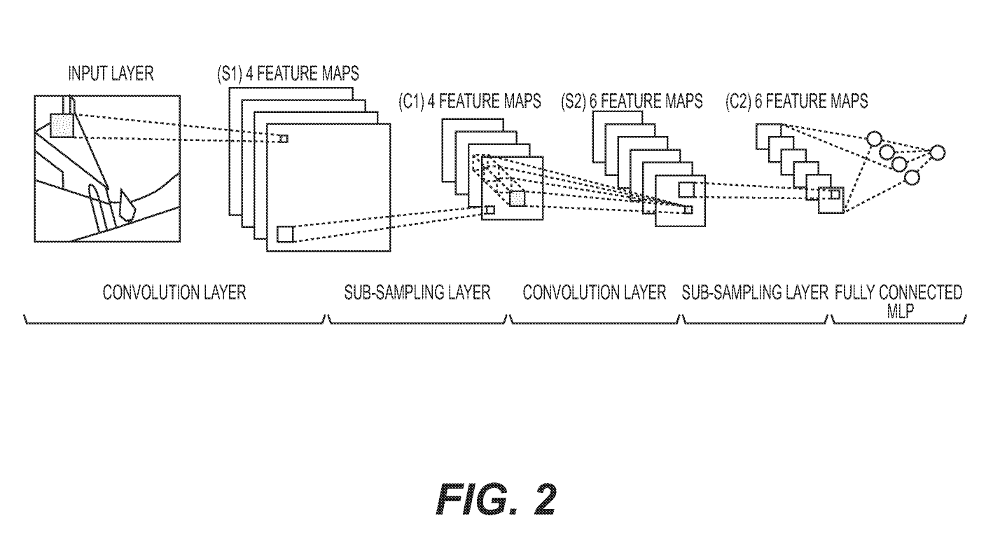

### DETAILED DESCRIPTION

The invention is described more fully hereinafter with references to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. It will be understood that for the purposes of this disclosure, “at least one of each” will be interpreted to mean any combination the enumerated elements following the respective language, including combination of multiples of the enumerated elements. For example, “at least one of X, Y, and Z” will be construed to mean X only, Y only, Z only, or any combination of two or more items X, Y, and Z (e.g. XYZ, XZ, YZ, X). Throughout the drawings and the detailed description, unless otherwise described, the same drawing reference numerals are understood to refer to the same elements, features, and structures. The relative size and depiction of these elements may be exaggerated for clarity, illustration, and convenience.

As explained above, vehicle implementers are implementing processors with increased capabilities, thereby attempting to perform the search for captured data via a complete database in an optimal manner. However, these techniques are limited in that they require increased processor resources, costs, and power to accomplish the increased processing.

The disclosure incorporates vehicle-based context information, obtainable via passive sensors, to augment object recognition in a vehicle-based context. Thus, by utilizing extra information available to a vehicle, the ability to process and retrieve information through a CNN (such as those described in the Background) is greatly enhanced.

In general, the aspects associated with the disclosure allow an increase in the object recognition capabilities of vehicles. This can result in higher performance using the same amount of processing capacity or more, or the reduction in required processing capacity to achieve the same performance level, or a combination of these. Higher performance could mean for example more total objects that can be identified, faster object identification, more classes of objects that can be identified, more accurate object identification and more accurate bounding of object areas.

Specifically, the disclosure relies on the employment of passive-based audio equipment. By passive, it is meant that the microphone is configured such that as the vehicle traverses through a driving condition, the microphone continually receives audio content from the vehicle's external environment.

One such technology employable is a beamforming microphone. Beamforming or spatial filtering is a signal processing technique used in sensor arrays for directional signal transmission or reception. This is achieved by combining elements in a microphone array in such a way that signals at particular angles experience constructive interference while others experience destructive interference. Beamforming can be used at both the transmitting and receiving ends in order to achieve spatial selectivity.

Disclosed herein are devices, systems, and methods for employing audio information that may be combined with visual information for an identification of an object in or around the environment of the vehicle. By employing the aspects disclosed herein, the need to incorporate more powerful processing power is obviated. As such, the ability to identify images, or objects in the images, is accomplished in a quicker fashion, with the gains being achieved of a cheaper, less resource intensive, and low power implementation of a vehicle-based processor. Further, and as mentioned above, all the advantages associated with higher performance may be achieved.

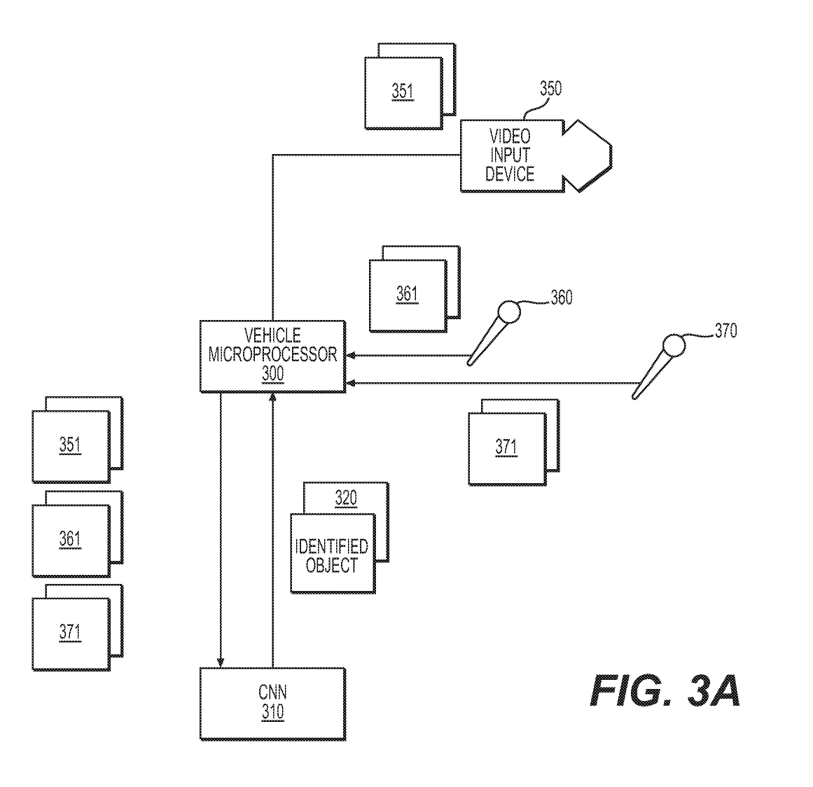

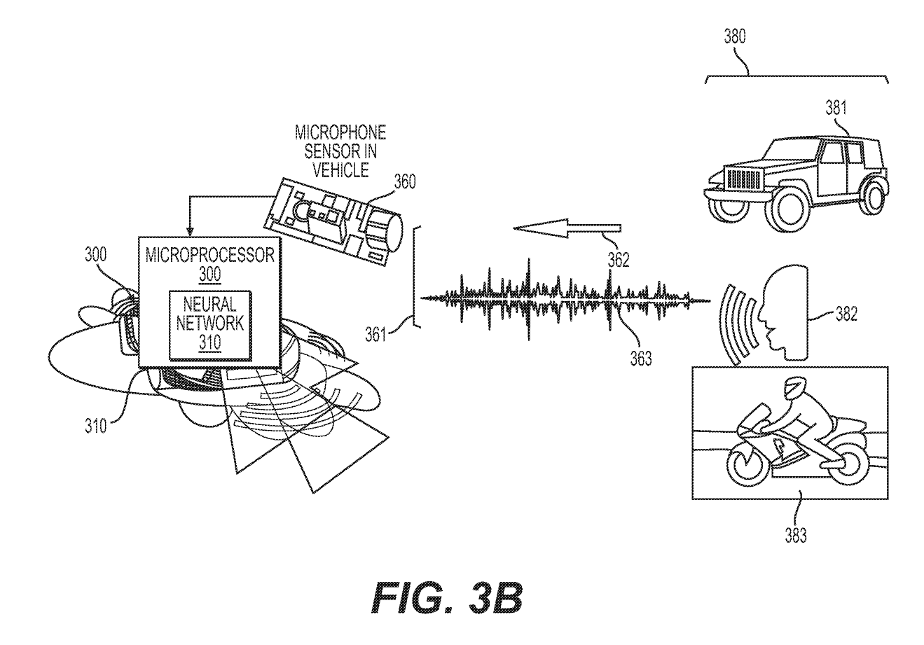

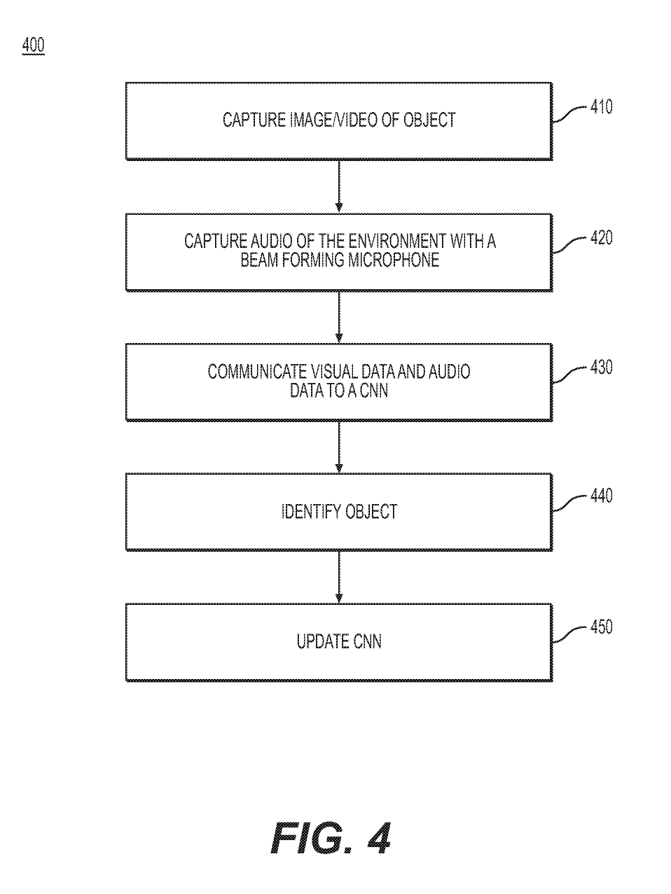

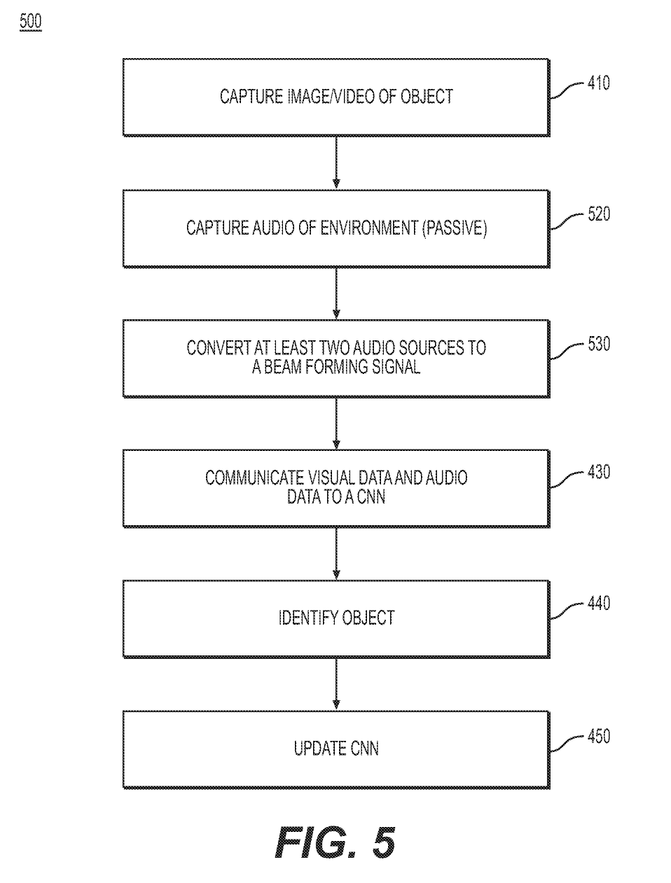

FIGS. 3(a) and (b) illustrate a vehicle microprocessor 300 implemented with a variety of sensors according to the aspects disclosed herein. As shown in FIG. 3(a) a vehicle microprocessor 300 is shown. By microprocessor, Applicants intend that any sort of programmable electronic device may be employed, such as a programmable processor, graphical processing unit, field programmable gate array, programmable logic device, and the like. Additionally, while one microprocessor is shown in FIG. 3. The vehicle microprocessor 300 may be configured with the operations shown in FIGS. 4 and 5.

The vehicle microprocessor 300 is electronically coupled to a variety of sensors. According to sample configurations shown in FIG. 3(a), and to the aspects described herein, at least one video/image input device 350 (such as an image camera, video camera, or any device capable of capturing visual information). Also provided are at least two microphones 360 and 370. Two are shown, but in other examples, the number of microphones constituting a microphone array may be selected based on the implementer's choice. In another example embodiment, only one microphone may be implemented. The microphone may be used to capture as much audio around the entire vehicle as possible, or might specifically be directed to a more forward or rear direction.

Microphones 360 and 370 may be beamforming microphones. Processing of the microphone outputs determines positional information. This processing could be specific processing associated with the microphone array for distance estimation (this processing being some type of conventional processing or a CNN), or this could be implemented within the CNN that also performs object identification. Furthermore, the output(s) of the object identification CNN could be fed back into the distance estimation processing to enhance performance of the position estimation (i.e. accuracy, speed of calculation). While several of the aspects disclosed herein are described with a CNN, a neural network (NN) may also be used.

Additionally, and in another embodiment, the beamforming microphones may be equipped with automatic movement devices. These automatic movement devices allow the microphones 360 and 370 (and other microphones not shown) to be oriented in a manner optimal to record sound. The control of the beamforming microphones may also be accomplished with a CNN, wherein the control would be subsequently trained through iterative operations. In another example, two microphones employing a processor to convert said recorded signals to a beam forming signal may also be employed (independent of a NN or CNN).

In another example, the microphones 360 and 370 may be non-beamforming, and essentially be inputted into a processor, such as a CNN 310, and converted into a beam-formed signal. This embodiment is further described in FIG. 5.

As shown in FIG. 3(a), the various sensors are configured to capture data associated with the sensing abilities of the sensors. Thus, the video sensor 350 is configured to capture image or video data 351. At the same time, the two microphones 360 and 370, each record audio 361 and 371 respectively.

This operation is highlighted in FIG. 3(b), where microphone 360 is configured to capture audio 372 from an object 380. As shown in FIG. 3(b), the object 380 may be one of the following objects exemplified, such as a vehicle 381, a pedestrian 382, and a motorcycle 383. The specific sound 373 is recorded by microphone 360 and at least one other microphone (such as microphone 370). Employing the spatial and locational aspects of a beam formed signal, these sounds are correlated to a perceived object as captured by the video sensor 350. In the use case of a single microphone, some positional information can also be derived, depending on an algorithms used (e.g. Doppler processing, spectral processing and echo processing). Such algorithms would generally be implemented in conventional processing devices (non-GPU), but possibly also in GPU-based processing devices.

The vehicle microprocessor 300 is configured to receive the data (351, 361, and 371), and propagate said data to the CNN 310. Employing the aspects disclosed herein, and as highlighted in either method 400 (FIG. 4) or method 500 (FIG. 5), the CNN 310 is employed to identify the object. Not shown in 3(b) is a camera 350. In some implementations a camera 350 may be provided, in others it is excluded, and the microphones 360 and/or 370 are only used.

In operations 410 and 420 (in no particular order), image data of an object and sound data (captured by a beamforming microphone) of the object is obtained. This may be done employing the described peripherals shown in FIGS. 3(a) and (b).

In operation 430, this captured data (image/video data and audio data) is propagated/communicated through an electronic coupling to a CNN for object identification. The CNN 310 is shown as a separate element in FIG. 3(a). In some embodiments, the CNN 310 may be implemented in the vehicle's microprocessor 300. Alternatively, it may be provided via a networked connection, for example, via a centralized server, a cloud-based implementation, a distributed processor machine, or the like.

In operation 440, employing both the visual data and the audio data, a CNN is employed to perform object identification. Once the object is identified, it may be propagated to the vehicle microprocessor 300 or another party that may employ the identification data for one or more objects identified, such identification data exemplified by object class or type, and object position.

Alternatively, the CNN 310 may learn from the operation in operation 440, and update the neural connections in the CNN 310 based on the correlated audio with the object. In this case, the CNN 310 is made to be more efficient in subsequent operations.

FIG. 4 illustrates a second method 500 detailing the operation of the vehicle microprocessor 300 employing the aspects disclosed herein to perform object detection. The method 500 is similar to method 400, as such, the similar operations will be omitted in this description.

A key distinction is that operation 420 in method 500 is omitted. Alternatively, in operation 520, a non-beamforming set of at least two microphones are employed to record audio data (operation 520). These non-beamforming microphones are configured to record data, and input data into a CNN (operation 530). This operation leads to the non-beamforming audio signals being converted to a beamforming signal. The beamforming signal may be employed in operation 430. In another example, the multiple microphones being employed may input data into the NN or CNN, and beam forming may not be employed.

Thus, employing the aspects associated with the disclosure allow an increase in the object recognition capabilities of vehicles. This can result in higher performance using the same amount of processing capacity or more, or the reduction in required processing capacity to achieve the same performance level, or a combination of these. Higher performance could mean for example more total objects that can be identified, faster object identification, more classes of objects that can be identified, more accurate object identification and more accurate bounding of object areas.

Certain of the devices shown include a computing system. The computing system includes a processor (CPU) or a graphics processor (GPU) and a system bus that couples various system components including a system memory such as read only memory (ROM) and random access memory (RAM), to the processor. Other system memory may be available for use as well. The computing system may include more than one processor or a group or cluster of computing systems networked together to provide greater processing capability. The system bus may be any of several types of bus structures including a memory bus or memory controller, a peripheral bus, and a local bus using any of a variety of bus architectures. A basic input/output (BIOS) stored in the ROM or the like, may provide basic routines that help to transfer information between elements within the computing system, such as during start-up.

To enable human (and in some instances, machine) user interaction, the computing system may include an input device, such as a microphone for speech and audio, a touch sensitive screen for gesture or graphical input, keyboard, mouse, motion input, and so forth. An output device can include one or more of a number of output mechanisms. In some instances, multimodal systems enable a user to provide multiple types of input to communicate with the computing system. A communications interface generally enables the computing device system to communicate with one or more other computing devices using various communication and network protocols.

Embodiments disclosed herein can be implemented in digital electronic circuitry, or in computer software, firmware, or hardware, including the herein disclosed structures and their equivalents. Some embodiments can be implemented as one or more computer programs, i.e., one or more modules of computer program instructions, encoded on a tangible computer storage medium for execution by one or more processors. A computer storage medium can be, or can be included in, a computer-readable storage device, a computer-readable storage substrate, or a random or serial access memory. The computer storage medium can also be, or can be included in, one or more separate tangible components or media such as multiple CDs, disks, or other storage devices. The computer storage medium does not include a transitory signal.

As used herein, the term processor (or microprocessor) encompasses all kinds of apparatus, devices, and machines for processing data, including by way of example a programmable processor, a computer, a system on a chip, or multiple ones, or combinations, of the foregoing. The processor can include special purpose logic circuitry, e.g., an FPGA (field programmable gate array) or an ASIC (application-specific integrated circuit). The processor also can include, in addition to hardware, code that creates an execution environment for the computer program in question, e.g., code that constitutes processor firmware, a protocol stack, a database management system, an operating system, a cross-platform runtime environment, a virtual machine, or a combination of one or more of them.

A computer program (also known as a program, module, engine, software, software application, script, or code) can be written in any form of programming language, including compiled or interpreted languages, declarative or procedural languages, and the program can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

To provide for interaction with an individual, the herein disclosed embodiments can be implemented using an interactive display, such as a graphical user interface (GUI). Such GUI's may include interactive features such as pop-up or pull-down menus or lists, selection tabs, scannable features, and other features that can receive human inputs.

The computing system disclosed herein can include clients and servers. A client and server are generally remote from each other and typically interact through a communications network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

As a person skilled in the art will readily appreciate, the above description is meant as an illustration of implementation of the principles this invention. This description is not intended to limit the scope or application of this invention in that the invention is susceptible to modification, variation and change, without departing from spirit of this invention, as defined in the following claims.

1. A system for employing audio for object detection, comprising:
an image capturing device configured to capture image data;
a first microphone configured to capture audio data;
a microprocessor configured:
to receive the captured image data and the captured audio data,
to communicate the captured image data and the captured audio data to a neural network;
to perform object detection on the neural network to detect at least one object from the image data; and
to perform object detection on at least one audio-only object.

2. The system according to claim 1, wherein the first microphone is a beamforming microphone.

3. The system according to claim 2, further comprising a second microphone, wherein the first microphone captures a first audio data and the second microphone captures a second audio data.

4. The system according to claim 2, wherein the microprocessor is further configured:
to communicate the first audio data to the neural network;
to instruct the neural network to combine the first audio data and the second audio data to produce a beamforming audio data;
wherein the captured audio data communicated to the neural network is the produced beamforming audio data.

5. The system according to claim 1, wherein the identified object is further propagated to an autonomous driving system.

6. The system according to claim 3, wherein both the first microphone and a second microphone are beamforming microphones and are automatically controlled to be oriented in an optimal manner.

7. The system according to claim 1, wherein the first microphone is automatically controlled to be oriented in an optimal manner.

8. A method of object identification employing a neural network, comprising:
receiving image/video data from an image/video-based sensor;
receiving audio data from a beam formed microphone, the audio data employing temporal and spatial data to correlate with the received image/video data; and
communicating the received image/video data and the audio data to the neural network to detect at least one object in the image/video data;
performing a detection of the at least one object employing both the image/video data and the audio data;
performing object detection on at least one audio-only object; and
receiving the data associated with the at least one object and/or the at least one audio-only object in a vehicle-based microprocessor of a vehicle.

9. The method according to claim 8, wherein the data associated with at least one object is communicated to an autonomous driving system associated with the vehicle.

10. The method according to claim 8, further comprising updating the neural network based on the performed detection.

11. A method of object identification employing a neural network, comprising:
receiving image/video data from an image/video-based sensor;
receiving audio data from at least one microphone; and
communicating the received audio data to the neural network to produce a beam formed audio signal, the beam formed audio data employing temporal and spatial data to correlate with the received image/video data;
receiving the beam formed audio data via a vehicle-based microprocessor of a vehicle in which the method is implemented on;
communicating the received image/video data and the beam formed audio data to the neural network to detect at least one object in the image/video data;
performing a detection of the at least one object employing both the image/video data and the beam formed audio data;
performing object detection on at least one audio-only object; and
receiving data associated with the at least one object and/or the at least one audio-only object in a vehicle-based microprocessor of a vehicle.

12. The method according to claim 11, wherein the data associate with the at least one object is communicated to an autonomous driving system associated with the vehicle.

13. The method according to claim 11, further comprising updating the neural network based on the performed detection.

14. The method according to claim 11, wherein the output of the neural network is communicated back to the neural network, and the neural network is updated based on the output for subsequent operations.
